(19) United States
(12) Patent Application Publication
(10) Pub. No.: US 2026/0039165 A1
(43) Pub. Date: Feb. 5, 2026

(54) WINDING, WINDING ASSEMBLY, AND COMPONENT FOR AN ELECTRIC MACHINE

(71) Applicant: ZF FRIEDRICHSHAFEN AG, Friedrichshafen (DE)

(72) Inventors: Kaijun XU, Schonungen (DE); Stefan REUTER, Hammelburg (DE)

(21) Appl. No.: 19/099,531

(22) PCT Filed: Aug. 2, 2023
(86) PCT No.: PCT/EP2023/071451

§ 371 Date: Jan. 29, 2025

(30) Foreign Application Priority Data
Aug. 3, 2022 (DE) 10 2022 208 042.4

(51) Int. Cl. H02K 3/12; H02K 3/28

(52) U.S. Cl. CPC H02K 3/12; H02K 3/28

(57) ABSTRACT

A winding for a component of an electric machine, the component has an annular lamination stack with axially extending slots through the lamination stack for receiving partial strands of the winding in radially adjacently arranged winding layers. The winding layers have a radially outermost layer and a radially innermost layer, an intermediate layer adjacent the outer layer and a further intermediate layer adjacent the inner layer. A first partial amount of the winding is guided through the inner layer and the further intermediate layer, and a second partial amount of the partial strands is guided through the intermediate layer and the outer layer, and a third partial amount of the partial strands is guided through the outer layer and intermediate layer, and a fourth partial amount of the partial strands is guided through the further intermediate layer and the inner layer.

### CROSS REFERENCE TO RELATED APPLICATIONS

This is a U.S. national stage of Application No. PCT/EP2023/071451 filed Aug. 2, 2023. Priority is claimed on German Application No. DE 10 2022 208 042.4 filed Aug. 3, 2022, the contents of which are incorporated herein by reference.

### BACKGROUND OF THE INVENTION

### 1. Field of the Invention

The present disclosure is directed to a winding, a winding arrangement, a component for an electric machine, an electric machine, a transmission device, an electric axle drive, and a motor vehicle.

### 2. Description of the Related Art

Electric machines may include components with windings comprising, for example, copper wires, for conducting electrical energy for generating magnetic fields. The chording between rings of such windings can be implemented as flat wire windings based on additional interconnection elements or lost and additional motion on a complete winding layer of the component.

### SUMMARY OF THE INVENTION

Against this background, one aspect of the present invention provides an improved winding, an improved winding arrangement, an improved component for an electric machine, an improved electric machine, an improved transmission device, an improved electric axle drive, and an improved motor vehicle.

The winding presented herein can advantageously minimize the copper weight for implementing the chording and save material costs. Further, the winding has good manufacturability and a compact interconnection.

A winding for a component of an electric machine is provided in which the component comprises an annular lamination stack with a plurality of slots axially extending through the lamination stack for receiving partial strands of the winding in a plurality of radially adjacently arranged winding layers. The winding layers comprise at least one radially outermost outer layer and a radially innermost inner layer, at least one intermediate layer arranged adjacent the outer layer and a further intermediate layer arranged adjacent the inner layer. A first partial amount of the partial strands of the winding is guided through the inner layer and the further intermediate layer, and a second partial amount of the partial strands which corresponds to the first partial amount is guided through the intermediate layer and the outer layer, and a third partial amount of the partial strands which corresponds to the first partial amount and second partial amount is guided through the outer layer and intermediate layer, and a fourth partial amount of the partial strands which corresponds to the first partial amount, second partial amount and third partial amount is guided through the further intermediate layer and the inner layer.

The electric machine can be, for example, an electric drive motor or other electric machine, for example, for a vehicle. The electric machine can comprise various components, such as a rotor and a stator, for example. The component, for example, an annular stator, can be formed from a plurality of individual laminations as a lamination stack through which the slots for receiving the partial strands of the winding extend. The slots can be numbered consecutively along the circumference of the lamination stack so that each slot may be assigned a unique position. Each of the slots can receive a plurality of partial strands which can be arranged radially adjacent in the slot. The quantity of partial strands which can be received by a slot can correspond to a quantity of winding layers. Accordingly, the winding layers can make up different portions of the slots. The winding can be, for example, a flat wire winding, the individual partial strands of which may be formed, for example, as so-called hairpin wires, i.e., as electrically conductive wires with a hairpin-like geometry which can be interconnected with one another on a twist side of the component. The winding can comprise, for example, four winding layers with an outer layer, an inner layer and, for example, two intermediate layers therebetween. The partial strands of the winding can be guided in each instance through winding layers arranged adjacent one another. For example, a partial strand of the first partial amount can be guided from the inner layer to the further intermediate layer and interconnected with a second partial strand which can likewise be guided from the inner layer to the further intermediate layer. The partial strands can be guided, for example, parallel to one another and spaced from one another along a circumference of the lamination stack. Similarly, by way of example, a partial strand of the second partial amount can be guided from the intermediate layer to the outer layer and interconnected with a second partial strand of the second partial amount, which can likewise be guided from the intermediate layer to the outer layer. Similarly, partial strands of the third partial amount can be guided in each instance from the outer layer to the intermediate layer, and partial strands of the fourth partial amount can be guided in turn from the further intermediate layer to the inner layer. In an advantageous manner, virtually all of the partial strands of the winding can have the same size, i.e., the same coil pitch, as a result of which the manufacturability can be simplified. Every partial amount can comprise an equal quantity of partial strands in order to advantageously enable a uniform distribution and, therefore, an optimized winding. Winding pitches of a winding layer or of a ring for a so-called ring jump can be correspondingly reduced depending on the degree of chording of the winding and positioned in an intermediate layer. Advantageously in this way, the winding pitch can remain normal at other locations and an optimal winding head height, for example, of a stator, can be realized with or without chording. Additional interconnection elements can be eliminated, resulting in economy of material and costs.

According to one aspect, the first partial amount and the second partial amount of partial strands can be wound along a first main direction of the winding, and the third partial amount and fourth partial amount of the partial strands can be wound along a second main direction of the winding opposite to the first main direction. For example, the winding can comprise twenty-four partial strands which can be wound, for example, in four winding layers along the annular lamination stack. In so doing, the first half of the partial strands, for example, can be wound in the first main direction, for example, in clockwise direction, along the ring shape of the lamination stack. The second half of the partial strands can then be wound in the opposite, second main direction, i.e., for example, counterclockwise.

According to one aspect, the partial amounts of the partial strands can correspond in each instance to one fourth of a total quantity of partial strands. The partial amounts can be adapted to a quantity of winding layers, for example. In a winding with four winding layers, for example, a winding layer can be formed in each instance, for example, from one fourth of the total number of partial strands. This has the advantage that the partial strands of the winding can be uniformly distributed on the individual winding layers. When the winding comprises, for example, a greater quantity of winding layers, the partial amounts of the partial strands can also be uniformly distributed to the layers. For example, with a quantity of six winding layers, every partial amount of the partial strands can comprise one sixth of the total number of partial strands.

According to one aspect, a first partial strand of the first partial amount can be interconnected with an external connection and a last partial strand of the first partial amount can be interconnected with a first partial strand of the second partial amount. A last partial strand of the second partial amount can in turn be interconnected with a first partial strand of the third partial amount, and a last partial strand of the third partial amount can be interconnected with a first partial strand of the fourth partial amount, and a last partial strand of the fourth partial amount can be interconnected with a further external connection. For example, the last partial strands of the first partial amount can exit from the further intermediate layer and be interconnected with the first partial strand of the second partial amount which, for example, enters in the adjacently arranged intermediate layer. Accordingly, an interconnection between the individual partial amounts can be carried out in each instance, by way of example, over adjacently arranged winding layers or, for example, within the same winding layers in order to advantageously enable a compact wiring with minimum copper weight and minimum winding head size. Further, a voltage can advantageously be applied via the external connection and the further external connection in order to enable a flow of current in the winding.

In addition, further partial strands of the first partial amount can be interconnected with one another so as to span layers. Additionally or alternatively, further partial strands of the second partial amount can be interconnected with one another in a layer-spanning manner and, additionally or alternatively, further partial strands of the third partial amount can be interconnected with one another in a layer-spanning manner and, additionally or alternatively, further partial strands of the fourth partial amount can be interconnected with one another in a layer-spanning manner. The individual partial strands can be inserted, for example, as hairpins in the corresponding slots in the lamination stack and interconnected with one another at a twist side of the winding. For this purpose, for example, two free end portions of two partial strands can be bent toward one another and, for example, electrically conductively coupled with one another or twisted around one another. The individual partial strands can be guided parallel to one another in each instance, for example. By way of example, a first partial strand of the first partial amount can enter in the inner layer and exit in the adjacently arranged further intermediate layer. A first output position of the first partial strand can be arranged spaced from a first input position of the first partial strand along the circumference of the lamination stack. This first partial strand can be interconnected with a second partial strand of the first partial amount which, for example, can enter in the inner layer of the winding layers at a second input position which is spaced from the first output position along the circumference and, like the first partial amount, can exit in the further intermediate layer at a second output position which is again spaced apart. In this way or in a similar manner, the partial strands can be guided along respective adjacent winding layers in a zigzag manner and interconnected with one another. The partial strands of the second partial amount can similarly be guided in the intermediate layer and the outer layer and interconnected in a layer-spanning manner. Likewise, the partial strands of the third partial amount can be guided in the outer layer and the intermediate layer and interconnected in a layer-spanning manner, and the partial strands of the fourth partial amount can likewise be guided in the further intermediate layer and the inner layer and interconnected in a layer-spanning manner.

According to one aspect, a partial strand of the second partial amount can be interconnected within the outer layer with a partial strand of the third partial amount. For example, a last partial strand of the second partial amount can be guided from the intermediate layer to the outer layer and interconnected within the outer layer with a first partial strand of the third partial amount which is spaced apart along the circumference of the lamination stack. The first partial strand of the third partial amount can in turn enter in outer layer and exit in the adjacently arranged intermediate layer and be interconnected with a further partial strand of the third partial amount. A change in direction of the winding can advantageously be brought about with the interconnection of the two partial strands within the outer layer. For example, the partial strands of the first partial amount and of the second partial amount can be wound along a first main direction of the winding, and the partial strands of the third partial amount and of the fourth partial amount can be wound along an opposite, second main direction of the winding.

Further, a winding arrangement with at least one first partial winding and a second partial winding is presented. The first partial winding and, additionally or alternatively, the second partial winding corresponds to a variant of the previously presented winding. For example, a winding arrangement can comprise two or three partial windings which are wound parallel to one another according to an identical or similar pattern. For example, the same phase can be carried in all of the partial windings.

Further, a component is presented for an electric machine with a variant of the previously presented winding. The component further comprises the annular lamination stack with the plurality of slots axially extending through the lamination stack for receiving the partial strands of the winding in a plurality of radially adjacently arranged winding layers. As a result of this combination, the advantages described above can advantageously be realized in an optimal manner. For example, the component can comprise three of the windings described above in order to carry, for example, three different phases, all of the windings being windable according to the same winding scheme. A compact component with optimized wiring of the individual phases can advantageously be realized in this way.

An electric machine can comprise an aforementioned component which can be constructed either as a stator or as a rotor. For example, the component can comprise three of the aforementioned windings.

The electric machine is suitable, for example, for an electric axle drive. Such an electric axle drive for a motor vehicle comprises at least one aforementioned electric machine, a transmission device and a power converter. The power converter can be constructed, for example, as an inverter. An electric current required for the operation of the electric machine can be supplied using the power converter. A torque provided by the electric machine can be transformed into a drive torque for driving at least one wheel of the motor vehicle using the transmission device. The transmission device can have a transmission for reducing the speed of the electric machine and, optionally, a differential.

Correspondingly, a motor vehicle can comprise an aforementioned electric machine and, additionally or alternatively, an aforementioned electric axle drive.

### BRIEF DESCRIPTION OF THE DRAWINGS

The invention will be described in more detail by way of example referring to the accompanying drawings. The drawings show:

FIG. 1 is a schematic side view of a component of an electric machine with a winding;

FIG. 2 is a schematic fragmentary view of the components with a winding arrangement;

FIG. 3 is a schematic fragmentary view of a component with a winding;

FIG. 4 is a tabular representation of a winding scheme for a winding arrangement;

FIG. 5 is a schematic diagram of a winding scheme;

FIG. 6 is a schematic view of a first partial strand; and

FIG. 7 is a schematic view of a motor vehicle.

### DETAILED DESCRIPTION OF THE PRESENTLY PREFERRED EMBODIMENTS

In the following description of preferred embodiment examples of the present invention, the same or like reference numerals are used for the elements illustrated in the various figures having similar functionality so as to avoid a repetitive description of these elements.

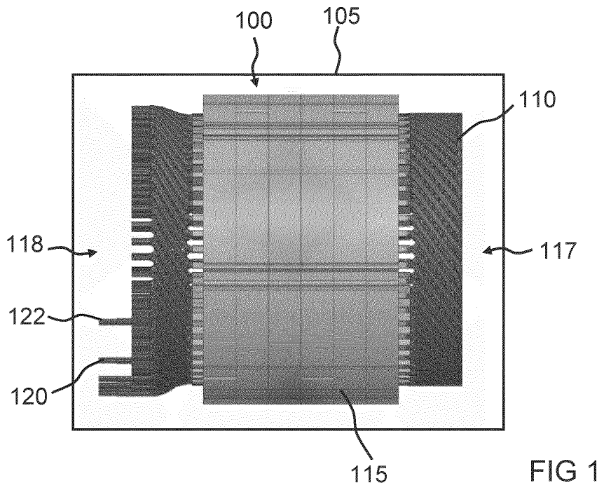

FIG. 1 shows a schematic side view of a component 100 of an electric machine 105 with a winding 110 according to an embodiment example. Component 100 is formed, merely by way of example, as a stator and comprises an annular lamination stack 115 with a plurality of slots axially extending through the lamination stack for receiving partial strands of the winding 110 in a plurality of radially adjacently arranged winding layers. The winding layers comprise a radially outermost outer layer, a radially innermost inner layer, an intermediate layer arranged adjacent the outer layer, and a further intermediate layer arranged between the prior intermediate layer and the inner layer.

The partial strands of winding 110 are formed, merely by way of example, as flat wires with a hairpin-like geometry for conducting a flow of electrical energy and may therefore also be referred to as hairpins or hairpin wires. By way of example, every hairpin has two portions or legs which are guided in each instance through a slot of the lamination stack and are interconnected with one another via a crown side 117 of component 100. The free ends of each hairpin wire are connectable with another wire at a twist side 118 opposite crown side 117. For conducting a current, winding 110 further has an external connection U1 and a further external connection U2. A voltage can be applied to the entire winding by the external connections U1, U2, for example, to carry a particular phase.

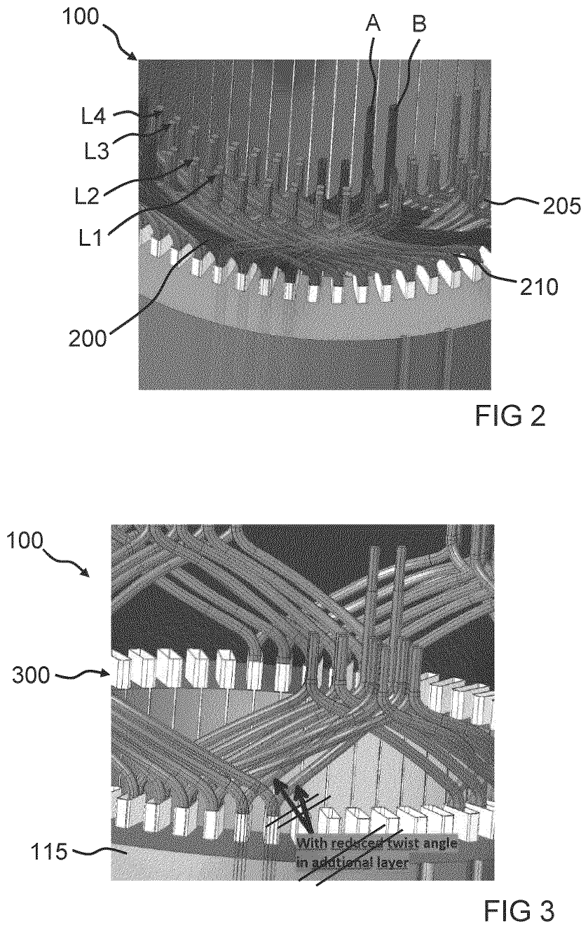

FIG. 2 shows a schematic fragmentary view of a component 100 with a winding arrangement 200 according to an embodiment example. The component 100 shown here corresponds to, or is similar to, the component described in the preceding figure and is shown from the twist side in the view depicted here.

In this embodiment example, the component is formed to receive a total of three winding arrangements 200, 205, 210. Merely by way of example, winding arrangements 200, 205, 210 are formed to carry a phase in each instance. Accordingly, in an example, winding arrangement 200 is formed, merely by way of example, to carry a U phase. A further winding arrangement 205 is formed, by way of example, to carry a W phase, and an additional winding arrangement 210 is formed, merely by way of example, to carry a V phase. Every winding arrangement 200, 205, 210 is wound in the same way, so the following description of winding arrangement 200 also applies similarly to the further winding arrangement 205 and the additional winding arrangement 210.

Winding arrangement 200 comprises a first partial winding A and a second partial winding B which may also be referred to as branches or paths. Both partial windings A, B correspond to the embodiment example of a winding as was described in the preceding figure and are wound, for example, parallel to one another in a total of four winding layers L1, L2, L3, L4. Winding layers L1, L2, L3, L4 comprise a radially outermost outer layer L1 and an intermediate layer L2 arranged adjacent the outer layer L1. Opposite outer layer L1, a further intermediate layer L3 is arranged adjacent intermediate layer L1. A radially innermost inner layer LA of the winding layers is in turn arranged adjacent further intermediate layer L3.

Each partial winding A, B of winding arrangement 200 comprises a plurality of partial strands which, merely by way of example, are formed as hairpins and interconnected with one another at the twist side of the winding. For this purpose, a first partial amount of the partial strands of first partial winding A is guided through inner layer L4 and further intermediate layer L3 and, by way of example, interconnected in a layer-spanning manner. A second partial amount of the partial strands of first partial winding A which corresponds to the first partial amount is guided through intermediate layer L2 and outer layer L1 and, also by way of example, interconnected in a layer-spanning manner. A third partial amount of the partial strands of the first partial winding A which corresponds to the first partial amount and second partial amount is guided through outer layer L1 and intermediate layer L2 and interconnected in a layer-spanning manner, and a fourth partial amount of the partial strands of first partial winding A which corresponds to the first partial amount, second partial amount and third partial amount is guided through further intermediate layer L3 and inner layer L4 and interconnected in a layer-spanning manner. In an embodiment example, the partial amounts correspond, respectively, to one fourth of a total quantity of partial strands of first partial winding A.

In this example, partial winding B of winding arrangement 200 is wound with the same quantity of partial strands as that of partial winding A and according to the same winding pattern and is wound in parallel to partial winding A.

Owing to the described manner of winding, adjacent winding layers L1, L2 and winding layers L3, L4 are closely interwoven, which is why these pairs can also be referred to as wreaths or rings. Accordingly, an interconnection of a partial strand of the first partial amount with a partial strand of the second partial amount or an interconnection of a partial strand of the third partial amount with a partial strand of the fourth partial amount over intermediate layer L2 and further intermediate layer L3 can also be referred to as a ring jump. Such a ring jump in the component presented herein takes place in every branch in the lowest possible number, as a result of which the entire winding arrangement 200 and, with it, also further winding arrangement 205, which is guided in the same manner, and additional winding arrangement 210 are producible with a low expenditure of labor and economically with respect to material and installation space.

FIG. 3 shows a schematic fragmentary view of a component 100 with a winding 110 according to an example. The component 100 shown here corresponds to, or is similar to, the component described in the preceding figures and is shown in the view illustrated here from the twist side. Component 100 comprises an annular lamination stack 115 with a plurality of slots 300 axially extending through the lamination stack 115 for receiving partial strands of winding 110 in a plurality of radially adjacently arranged winding layers. In this example, winding 110 comprises four winding layers, each winding layer corresponding to a radial position of a partial strand of winding 110 within slots 300. The partial strands of winding 110 are interconnected with one another on the twist side, shown in FIG. 3, of component 100 so as to span winding layers which are adjacent one another. A twist angle in which partial strands which are bent toward one another are oriented is reduced in this way.

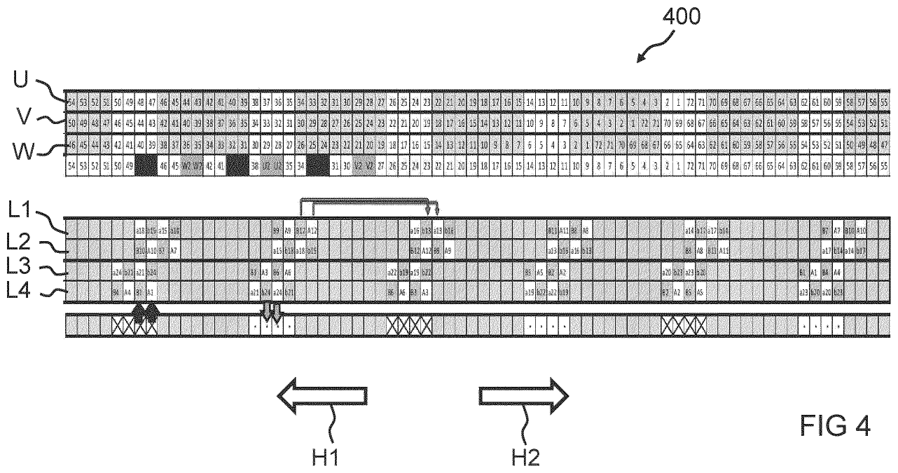

FIG. 4 shows a tabular representation of an example of a winding scheme 400 for a winding arrangement which was described in the preceding FIG. 2. The winding arrangement comprises a first partial winding A and a second partial winding B. The two partial windings A, B correspond to a winding which was described in the preceding FIGS. 1 and 3.

The winding scheme 400 illustrated here is configured, by way of example, for a component with a lamination stack with, by way of example, seventy-two slots and a hole number 3 for receiving a total of three windings in which, by way of example, phases U, W and V can be carried. Positions 1 to 72 of the slots along the circumference of the lamination stack are indicated in the top three rows of the table. The row at the top corresponds to a variant of the winding arrangement carrying a U phase, the row below that corresponds to a variant of the winding arrangement carrying a W phase, and the row below that corresponds to a variant of the winding arrangement carrying a V phase. The positions of the respective connections of the individual phases are indicated in the fourth row.

The four rows below the position markings correspond to, by way of example, four winding layers of the winding. The top row corresponds to the radially outermost outer layer L1 of the winding. Intermediate layer L2 is arranged below outer layer L1 in the table shown here and is meant as a winding layer arranged radially adjacent the outer layer L1 in the lamination stack. Similarly, the row below that refers to the radially innermost layer L4 of the winding which is arranged radially adjacent further intermediate layer L3. Inputs and outputs of partial strands of the winding are marked proceeding from a twist side of the winding in the bottom row of winding scheme 400.

In the example shown here, winding scheme 400 is represented, merely by way of example, based on a winding arrangement for carrying the U phase.

In this example, the winding arrangement comprises two parallel partial windings A, B with, respectively, twenty-four partial strands interconnected with one another. Partial windings A, B may also be referred to as paths or branches of the winding arrangement and are wound parallel to one another. Correspondingly, the following description of the first partial winding A similarly applies to the second partial winding B, and the respective partial strands of partial windings A, B are arranged to be spaced from one another by one to three slots along a circumference of the lamination stack.

In this example, first partial winding A comprises a total quantity of, for example, twenty-four partial strands. A first partial strand A1 of a first partial amount of the partial strands is interconnected with an external connection U1. In this embodiment example, first partial strand A1 enters in inner layer L4 of the winding layers at a first input position 47 (see first row of winding scheme 400), is guided from there through the lamination stack of the component and exits again in further intermediate layer L3 arranged adjacent inner layer L4 at a first output position 61. First input position 47 and first output position 61 are arranged to be spaced from one another, for example, by fourteen slots. First partial strand A1 of the first partial amount is interconnected with a second partial strand A2 proceeding, by way of example, from first output position 61. Similar to first partial strand A1, second partial strand A2 enters in inner layer L4 at a second input position 1 and exits in further intermediate layer L3 at a second output position 11. Correspondingly, in this embodiment example, first partial strand A1 and second partial strand A2 with a spacing of twelve slots and a twist step of six slots in each instance resulting therefrom are interconnected with one another in a layer-spanning manner. Second partial strand A2 is, for example, interconnected with a third partial strand A3 of the first partial amount, and third partial strand A3 is guided from inner layer L4 to further intermediate layer L3 like the first partial strand A1 and second partial strand A2. In accordance with this pattern, the first partial amount of partial strands of partial winding A is guided through inner layer L4 and further intermediate layer L3 and, in each instance, interconnected in a layer-spanning manner. The first partial amount of partial strands in an embodiment example corresponds to one fourth of the total quantity of partial strands of partial winding A.

In this example, a last partial strand A6 of the first partial amount is interconnected with a first partial strand A7 of the second partial amount. For this purpose, last partial strand A6 of the first partial amount exits in further intermediate layer L3 at a sixth output position 35 and is interconnected, by way of example, in a layer-spanning manner with the first partial strand A7 of the second partial amount. In this embodiment example, first partial strand A7 enters in intermediate layer L2 at a seventh input position 45 spaced apart by ten slots. This interconnection between intermediate layers L3, L2 may also be referred to as a ring jump.

First partial strand A7 of the second partial amount of partial strands enters in intermediate layer L2 at the seventh input position 45 and exits in outer layer L1 at a seventh output position 59. Proceeding from seventh output position 59, first partial strand A7 of the second partial amount is interconnected with a second partial strand A8 of the second partial amount, and second partial strand A8 of the second partial amount enters in intermediate layer L2 and exits from outer layer L1 similar to first partial strand A7. In the same manner, second partial strand A8 of the second partial amount is interconnected, by way of example, with a third partial strand A9 of the second partial amount, and third partial strand A9 is guided from intermediate layer L2 to outer layer L1 like first partial strand A7 and second partial strand A8. The second partial amount of partial strands of partial winding A is guided in accordance with this pattern through intermediate layer L2 and outer layer L1 and is interconnected in a layer-spanning manner in each instance. In an embodiment example, the second partial amount of partial strands corresponds to one fourth of the total quantity of partial strands of partial winding A.

In this example, the first partial amount and the second partial amount of partial strands of partial winding A are wound along a first main direction H1 of the winding. First main direction H1 corresponds, in a merely exemplary manner, to a counterclockwise winding direction when the component is considered from the twist side.

In this example, a last partial strand A12 of the second partial amount is interconnected with a first partial strand A13 of the third partial amount. For this purpose, in this embodiment example, the last partial strand A12 of the second partial amount is interconnected with first partial strand a13 of the third partial amount within outer layer L4 proceeding from a twelfth output position 33, and first partial strand a13 enters in outer layer L4 at a thirteenth input position 22 spaced apart from the twelfth output position 33 along the circumference.

In this example, first partial strand a13 of the third partial amount is guided from the thirteenth input position 22 to a thirteenth output position 12 in intermediate layer L2 and is interconnected with a second partial strand a14 of the third partial amount which enters in outer layer L1 at a fourteenth input position 72 and exits in intermediate layer L2 at a fourteenth output position 58. Second partial strand a14 of the third partial amount is in turn, by way of example, interconnected with a third partial strand a15 of the third partial amount which is likewise guided from outer layer L1 to intermediate layer L2. The partial strands of the third partial amount which, by way of example, correspond to one fourth of the total quantity of partial strands of partial winding A are guided in outer layer L1 and intermediate layer L2 parallel to the partial strands of the second partial amount, but are wound along a second main direction H2 of the winding opposite to the first main direction H1.

In this example, a last partial strand a18 of the third partial amount is interconnected with a first partial strand a19 of the fourth partial amount. This interconnection is carried out similar to the interconnection between last partial strand A6 of the first partial amount and first partial strand A7 of the second partial amount as a ring jump from intermediate layer L2 to further intermediate layer L3. Subsequently, first partial strand a19 of the fourth partial amount is guided, by way of example, along second main direction H2 from further intermediate layer L3 to inner layer L4 and is interconnected, by way of example, with a second partial strand a20 of the fourth partial amount which is likewise guided from further intermediate layer L3 to inner layer L4. The rest of the partial strands of the fourth partial amount which corresponds to one fourth of the total quantity of partial strands of partial winding A in this example are guided, respectively, parallel to one another along second main direction H2 through further intermediate layer L3 and inner layer LA and, by way of example, are interconnected with one another in a layer-spanning manner. In this example, a last partial strand a24 of the fourth partial amount is interconnected with the further external connection U2.

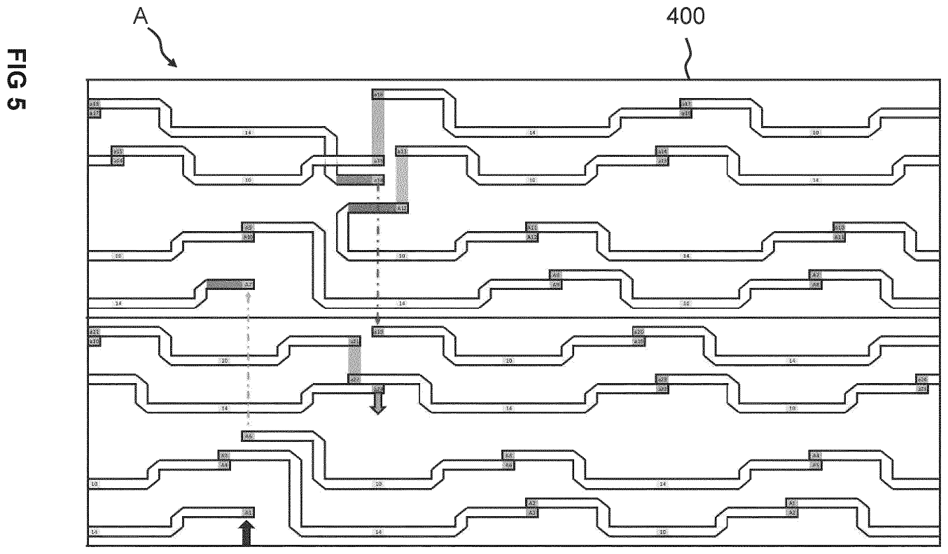

FIG. 5 shows a schematic view of a winding scheme 400 according to an example. The winding scheme 400 shown here corresponds to, or is similar to, the winding scheme described in the preceding FIG. 4. In the view shown here, the winding of first partial winding A is shown by way of example. The above-described inner layer and the further intermediate layer arranged adjacent the latter are shown in the lower half of the drawing, and the above-described intermediate layer and the outer layer are shown in the top half of the drawing.

In addition to the arrangement and interconnection of the partial strands of partial winding A, the respective coil pitch of the individual partial strands which are formed, for example, as hairpins is indicated merely by way of example in the view shown here. First partial strand A1 of the first partial amount has, merely by way of example, a coil pitch of fourteen slots, second partial strand A2 of the first partial amount has a coil pitch of ten slots, and third partial strand A3 of the first partial amount again has a coil pitch of fourteen slots. All of the remaining partial strands of partial winding A have, alternately, a coil pitch of ten and fourteen slots according to this pattern.

In this example, last partial strand A6 of the first partial amount is interconnected with first partial strand A7 of the second partial amount, as a result of which a ring jump occurs from the further intermediate layer shown in the lower half of FIG. 5 into the intermediate layer shown in the upper half of FIG. 5. A similar ring jump occurs through the interconnection of last partial strand a18 of the third partial amount with first partial strand a19 of the fourth partial amount, and partial strands a18, a19 are wound this time in the contrary direction from the intermediate layer back into the further intermediate layer. Every ring jump from every branch of the winding arrangement takes place into only one additional layer in order to realize a chording in an economical manner. Accordingly, winding scheme 400 has a good manufacturability and has a favorable installation space requirement. The costs for additional interconnection elements are done away with.

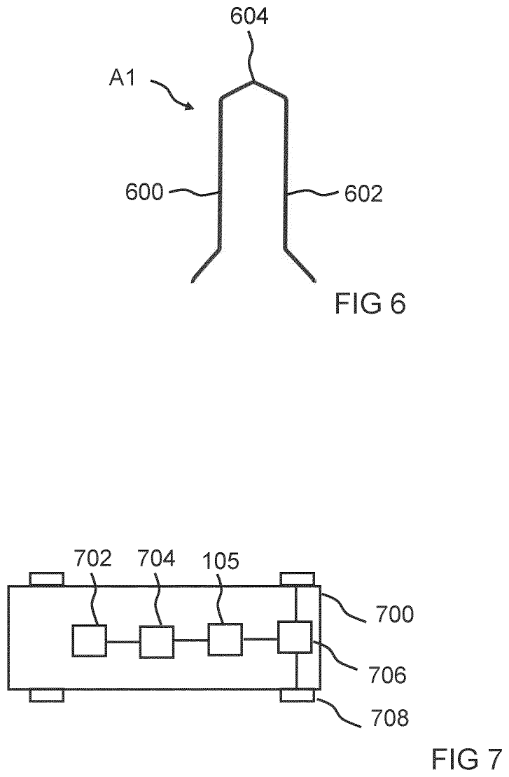

FIG. 6 shows a schematic view of a first partial strand A1 according to an example. The first partial strand A1 shown here corresponds to, or is similar to, the first partial strand described in the preceding FIGS. 4 and 5 and stands as an example for all of the partial strands of the winding which were described in the preceding figures. In this example, first partial strand A1 is formed as a flat wire from a copper material for conducting electrical energy and has a hairpin-like geometry. First partial strand A1 comprises an input portion 600 and an output portion 602 for guiding through a slot of a lamination stack of a component. The input portion and the output portion are connected, by way of example, by a connection portion 604.

FIG. 7 shows a schematic view of a motor vehicle 700. The motor vehicle has an electric axle drive with an electric machine 105 such as was described by way of example referring to the preceding FIG. 1. Electrical energy for the operation of electric machine 105 is supplied by a power supply device 702, for example, a battery. By way of example, a DC current provided by power supply device 702 is converted into an AC current, for example, a three-phase AC current, using a power converter 704 of the transmission device and is supplied to electric machine 105. Accordingly, electric machine 105 can be an electric motor which is operated with a three-phase

AC voltage. A shaft driven by electric machine 105 is coupled directly, or with the use of a transmission device 706, to at least one wheel 708 of motor vehicle 700. Accordingly, motor vehicle 700 can be driven in motion by electric machine 105. According to an aspect of the invention, the electric axle drive comprises a housing in which power converter 704, electric machine 105 and transmission device 706 are integrated.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1-11. (canceled)

12. A winding for a component of an electric machine, wherein the component comprises an annular lamination stack with a plurality of axially extending slots through the annular lamination stack configured to receive partial strands of the winding in a plurality of radially adjacently arranged winding layers, wherein the winding layers comprise:
at least one radially outermost outer layer;
a radially innermost inner layer, at least one intermediate layer arranged adjacent the outermost layer; and
a further intermediate layer arranged adjacent the inner layer, wherein:
a first partial amount of the partial strands of the winding is guided through the inner layer and the further intermediate layer;
a second partial amount of the partial strands of the winding, which corresponds to the first partial amount, is guided through the intermediate layer and the outer layer;
a third partial amount of the partial strands of the winding, which corresponds to the first partial amount and the second partial amount, is guided through the outer layer and intermediate layer; and
a fourth partial amount of the partial strands of the winding, which corresponds to the first partial amount, the second partial amount and the third partial amount, is guided through the further intermediate layer and the inner layer.

13. The winding according to claim 12, wherein the first partial amount and the second partial amount of partial strands are wound along a first main direction of the winding, and the third partial amount and the fourth partial amount of partial strands are wound along a second main direction of the winding opposite to the first main direction.

14. The winding according to claim 12, wherein each of the partial amounts of the partial strands correspond to one fourth of a total quantity of partial strands.

15. The winding according to claim 12, wherein:
a first partial strand of the first partial amount is interconnected with an external connection,
a last partial strand of the first partial amount is interconnected with a first partial strand of the second partial amount,
a last partial strand of the second partial amount is interconnected with a first partial strand of the third partial amount,
a last partial strand of the third partial amount is interconnected with a first partial strand of the fourth partial amount, and
a last partial strand of the fourth partial amount is interconnected with a further external connection.

16. The winding according to claim 15, wherein
further partial strands of the first partial amount are interconnected with one another in a layer-spanning manner and/or
further partial strands of the second partial amount are interconnected with one another in a layer-spanning manner and/or
further partial strands of the third partial amount are interconnected with one another in a layer-spanning manner and/or
further partial strands of the fourth partial amount are interconnected with one another in a layer-spanning manner.

17. The winding according to claim 15, wherein a partial strand of the second partial amount is interconnected within the outer layer with a partial strand of the third partial amount.

18. The winding according to claim 12, wherein the winding corresponds to at least one first partial winding and/or a second partial winding.

19. A component for an electric machine comprising:
a winding;
an annular lamination stack with a plurality of axially extending slots through the annular lamination stack configured to receive partial strands of the winding in a plurality of radially adjacently arranged winding layers,
wherein the winding layers comprise:
at least one radially outermost outer layer;
a radially innermost inner layer, at least one intermediate layer arranged adjacent the outermost layer; and
a further intermediate layer arranged adjacent the inner layer,
wherein:
a first partial amount of the partial strands of the winding is guided through the inner layer and the further intermediate layer;
a second partial amount of the partial strands of the winding, which corresponds to the first partial amount, is guided through the intermediate layer and the outer layer;
a third partial amount of the partial strands of the winding, which corresponds to the first partial amount and the second partial amount, is guided through the outer layer and intermediate layer; and
a fourth partial amount of the partial strands of the winding, which corresponds to the first partial amount, the second partial amount and the third partial amount, is guided through the further intermediate layer and the inner layer.

20. The component for an electric machine, according to claim 19, wherein the component is constructed as a stator or as a rotor of the electric machine and comprises three windings.

21. The component for an electric machine, according to claim 19, wherein the electric machine is coupled to an electric axle drive for a motor vehicle, a transmission device, and a power converter,

22. The component for an electric machine, according to claim 21, wherein the electric axle drive is arranged in a motor vehicle.
